(19) United States
(12) Patent Application Publication
(10) Pub. No.: US 2015/0120452 A1
(43) Pub. Date: Apr. 30, 2015

(54) Product Information by Consumer Movement

(71) Applicant: Wal-Mart Stores, Inc., Bentonville, AR (US)

(72) Inventor: Valerie Goulart, Seattle, WA (US)

(73) Assignee: Wal-Mart Stores, Inc., Bentonville, AR (US)

(21) Appl. No.: 14/169,631

(22) Filed: Jan. 31, 2014

Related U.S. Application Data
(63) Continuation-in-part of application No. 14/066,260, filed on Oct. 29, 2013.

(51) Int. Cl. G06Q 30/02; H04W 4/02

(52) U.S. Cl. CPC G06Q 30/0267; G06Q 30/0259; G06Q 30/0261; H04W 4/025
USPC 705/14.57

(57) ABSTRACT

A computer-implemented method is disclosed herein. The method includes the step of receiving, at a processing device of a commerce server, a series of position signals from a mobile electronic computing device possessed by a consumer. The method also includes the step of storing, in a product database, information about each of a plurality of products offered for sale. The method also includes the step of accessing, with the processing device, a location database to correlate each of the series of position signals with one or more particular physical locations from among a plurality of possible physical locations. The method also includes the step of storing, in a consumer movement database, the consumer's movements as defined by the one or more particular physical locations visited by the consumer. The method also includes the step of correlating, with the processing device, each of the one of the particular physical locations visited by the consumer with at least one of the plurality of products. The method also includes the step of selecting, with the processing device, a product promotion associated with the at least one of the plurality of products from the product database. The method also includes the step of transmitting, with the processing device, the product promotion to the mobile electronic computing device.

### RELATED APPLICATIONS

This application is a continuation in part of U.S. application Ser. No. 14/066,260, entitled “Product Information by Consumer Movement”, filed Oct. 29, 2013, the disclosure of which is incorporated herein by reference in its entirety.

### BACKGROUND INFORMATION

1. Field of the Disclosure

The present invention relates generally to optimizing the delivery of product promotions to consumers. In particular, examples of the present invention are related to systems for delivering product promotions to a consumer through a mobile electronic computing device wherein the promotions are selected based on particular physical locations that the consumer has visited.

2. Background

Product promotions and information can be delivered in print, audio and video formats. A product promotion can be a sale, a coupon, a price rollback, or some other attribute of the product that increases the desirability of the product to a consumer. Many consumers collect coupons or search through sale announcements when preparing to shop for products such as groceries, office supplies, and household wares. Consumers that do collect coupons may spend significant time teeming through the coupons and sale announcements in an effort to find deals and ultimately reduce the amount of money spent on products. One drawback for the consumers, however, is that collecting promotions such as coupons takes significant time. Further, the coupons may not be readily accessible when the consumer visits a retail store unless the consumer is willing to carry the coupons at all times. These drawbacks lead some consumers to determine that product promotions are not worth pursuing. The effectiveness of other kinds of product promotions can be similarly undermined.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example schematic illustrating a mobile electronic computing device that can be applied in some embodiments of the present disclosure.

FIG. 3 is an example block diagram illustration of a commerce server that can be applied in some embodiments of the present disclosure.

FIG. 4A is a perspective view of an operating environment of an exemplary embodiment of the present disclosure.

FIG. 4B is an illustration of a consumer's field of view showing an example screen display visible with the mobile electronic computing device after receipt of a product promotion.

FIG. 5 is an example flow chart illustrating a method that can be carried out according to some embodiments of the present disclosure

FIG. 6 is an example flow chart illustrating another method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

It can be desirable to deliver product promotions to a consumer wherein the promotions are selected in view of objective evidence of the consumer's interests. A product promotion can be coupon, a price rollback, or any other information that tends to induce a consumer to purchase the product, such as an attribute of the product or a consequence of purchase. The movement and travels of a consumer can objectively reveal the consumer's interests. Systems according to embodiments of the present disclosure can correlate the particular physical locations that a consumer has visited with products offered for sale in a retail store. A “retail store” can include a physical retail store and/or an online retail store.

Embodiments of the present disclosure empower consumers by providing systems for delivering targeted product promotions. A system according to an embodiment of the disclosure can include a commerce server configured to receive a series of position signals from a mobile electronic computing device possessed by a consumer. Each of the position signals can correspond to a particular physical location at which the consumer is present. The mobile electronic computing device can transmit data corresponding to the position of the consumer within a physical retail store and outside of a physical retail store. This data, correlated to data associated with products offered for sale within the retail store, can be processed and analyzed by the commerce server to select appropriate product promotions to transmit to the consumer. These promotions can be transmitted to the mobile electronic computing device and presented on a display of the mobile electronic computing device that is visible to the consumer.

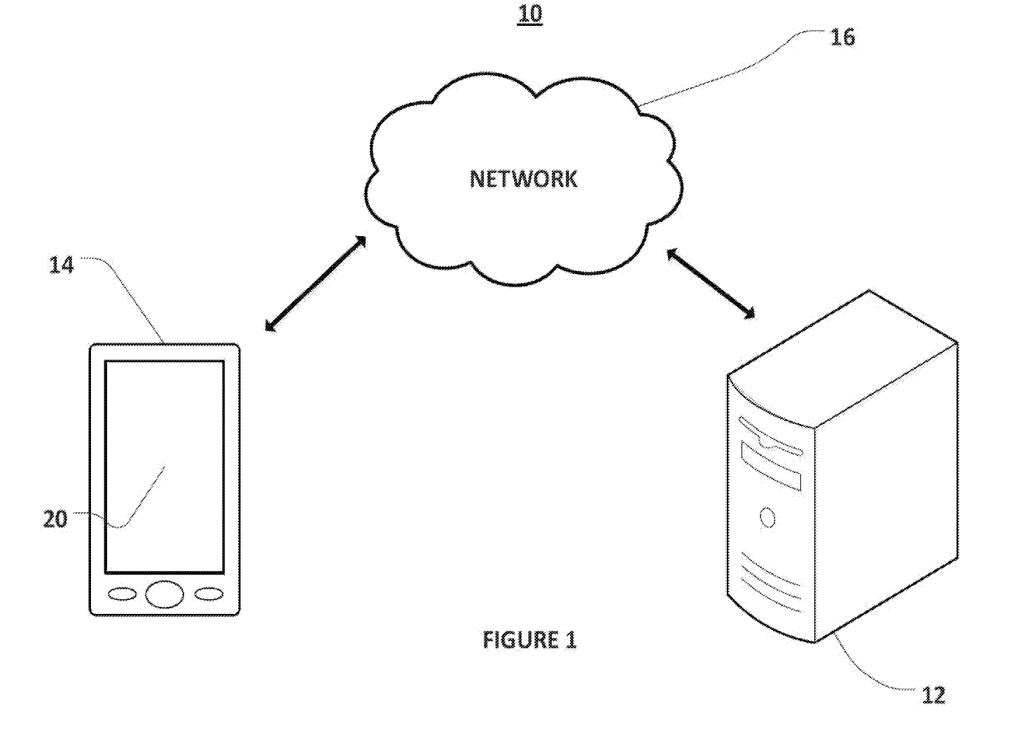

To illustrate, FIG. 1 is a schematic illustrating a product promotion system 10 according to some embodiments of the present disclosure. The product promotion system 10 can implement a computer-implemented method that includes the step of receiving, at a processing device of a commerce server 12, a series of position signals from a mobile electronic computing device 14. The one or more signals correspond to, or contain data indicative of, a position of the mobile electronic computing device 14. The position of the mobile electronic computing device 14 can be within a physical retail store or outside of a physical retail store. The mobile electronic computing device 14 can be possessed a consumer while moving within a physical retail store or outside of a physical retail store. The mobile electronic computing device 14 operated by the consumer can be a smart-phone, a tablet, an e-reader, or any other electronic computing device operable to receive and/or transmit position signals and data, such video data, audio data, and other forms of data.

Signals transmitted by the mobile electronic computing device 14 and received by the commerce server 12, and vice-versa, can be transmitted over a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The commerce server 12 can access a location database to correlate each of the series of position signals with one or more particular physical locations from among a plurality of possible physical locations. The location database can be integral with the commerce server 12 or remote from the commerce server 12. The location database can be operated and maintained by a party other than the owner of the commerce server 12. In some embodiments of the present disclosure, the commerce sever 12 can utilize a remote, third-party geographical “map” database and also maintain and utilize a supplemental location database; thus, the commerce server 12 can maintain at least a portion of the location database in some embodiments of the present disclosure. For example, the third-party database can contain physical address data, GPS data, location identity data and the supplemental location database can include business category data indicating the nature of the location, attractions available at the location, consumer reviews, and a schedule of events occurring at the location. The commerce server 12 can store, in a consumer movement database, the consumer's movements as defined by the one or more particular physical locations visited by the consumer.

Information about the products offered for sale in the retail store can be stored in a product database. Product promotions associated with the products can also be stored in the product database. The commerce server 12 can access and retrieve promotions from the product database.

In response to the signals received from the mobile electronic computing device 14, the commerce server 12 can correlate a particular physical location that is visited by the consumer with at least one of the plurality of products contained in the product database. The correlation can be made based on identical terms found in the entry for the product in the product database and in the entry for the location in the location database. The correlation can be made based on analogous or synonymous terms found in the entries for the product and the location. For example, a gym can be a location in the location database. The entry for the gym in the location database can include descriptive terms such as “exercise,” “health,” and/or “diet.” A food item can be a product in the product database. The entry for the food item in the product database can include descriptive terms such as “low fat,” “diet,” and/or “healthy.” The commerce server 12 can correlate the gym and the food item in response to the similar and/or identical terminology in the entries for the food item and the gym in the respective product and location databases.

The commerce server 12 may correlate a location to more than one product and the product database may contain more than one product promotion for a particular product. The commerce server 12 select one or more of the possible product promotions associated with one or more of the products and transmit the selected promotions to the mobile electronic computing device 14. The promotion can be selected based on the number of times a consumer visits a particular physical location. For example, a single visit to a particular physical location may not result in the transmission of promotion but more than three visits can result in the transmission of a promotion. The selection can also be made based on the number of promotions available for a product or a value of the promotion. For example, a single visit to a particular physical location may result in the transmission of promotion if the promotion is a fifty-percent-off coupon or if multiple promotions are available for a product associated with the particular physical location.

Embodiments of the present disclosure help consumers by providing product promotions that are sent based on some evidence tending to indicate that the consumer will be interested in the product. Further, the consumer is not required to exert effort to locate product promotions. The position signals can be automatically transmitted to a commerce server as the consumer engages in typical activities. The position data can correlated to data related to products offered for sale by a retail store. In some embodiments, the promotions can be delivered when the consumer enters the retail store to shop, however this feature is not required of embodiments of the present disclosure.

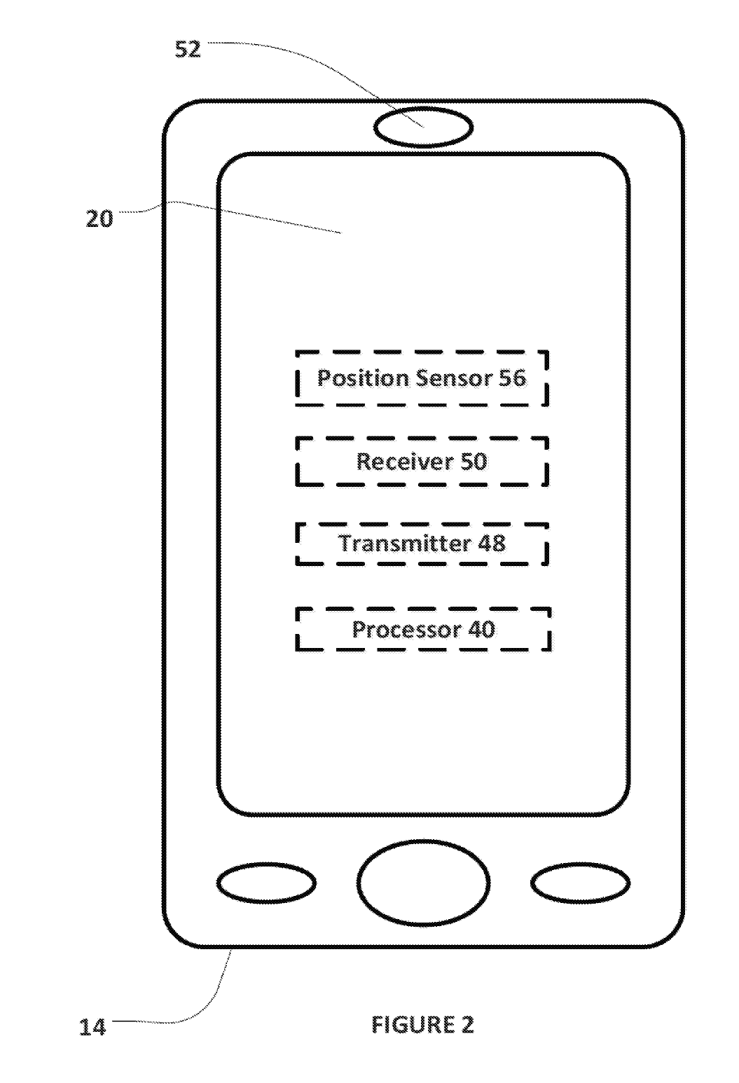

FIG. 2 is a schematic illustrating the components of an exemplary mobile electronic computing device 14. The mobile electronic computing device 14 can include a processor 40, the display 20, a transmitter 48, a receiver 50, one or more speakers 52, and a position sensor 56. The processor 40, the transmitter 48, the receiver 50, and the position sensor 56 are shown in dash line because these components are within the mobile electronic computing device 14 and therefore not visible.

The processor 40 can be operable to receive signals generated by the other components of the mobile electronic computing device 14. The processor 40 can also be operable to control the other components of the mobile electronic computing device 14. The processor 40 can also be operable to process signals received by the mobile electronic computing device 14. While one processor 40 is illustrated, it should be appreciated that the term “processor” can include two or more processors that operate in an individual or distributed manner.

The display 20 can be positioned within the consumer's field of view. Video content can be shown to the consumer with the display 20. The display 20 can be configured to display text, graphics, images, illustrations and any other video signals to the consumer.

The transmitter 48 can be configured to transmit signals generated by the other components of the mobile electronic computing device 14 from the mobile electronic computing device 14. The processor 40 can direct signals generated by components of the mobile electronic computing device 14 to the commerce sever 12 through the transmitter 48. The transmitter 48 can be an electrical communication element within the processor 40. In one example, the processor 40 is operable to direct signals to the transmitter 40 and the transmitter 48 is operable to transmit the signals from the mobile electronic computing device 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The mobile electronic computing device 14 can include one or more speakers 52. Each speaker 52 can be configured to emit sounds, messages, information, and any other audio signal to the consumer. The speaker 52 can be positioned within the consumer's range of hearing. Audio content transmitted by the commerce server 12 can be played for the consumer through the speaker 52. The receiver 50 can receive the audio signal from the commerce server 12 and direct the audio signal to the processor 40. The processor 40 can then control the speaker 52 to emit the audio content.

The position sensor 56 can be configured to generate a position signal indicative of the position of the consumer within a physical retail store or outside of the physical retail store. The position sensor 56 can be configured to detect an absolute or relative position of the consumer wearing the mobile electronic computing device 14. The position sensor 56 can electrically communicate a position signal containing position data to the processor 40 and the processor 40 can control the transmitter 48 to transmit the position signal to the commerce server 12 through the network 16.

Identifying the position of the consumer can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the consumer and are visible in the video signal. The commerce server 12 can receive position data and identify the location of the consumer in some embodiments of the present disclosure. The position sensor 56 can also utilize GPS signals to identify the position of the mobile electronic computing device 14.

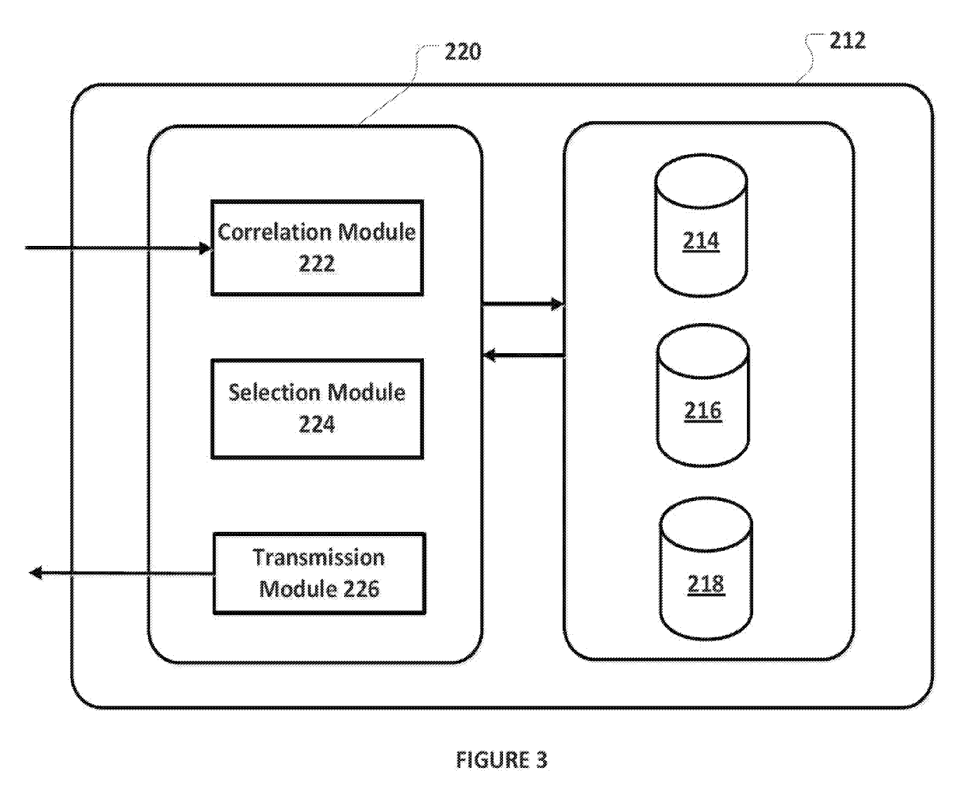

FIG. 3 is a block diagram illustrating a commerce server 212 according to some embodiments of the present disclosure. In the illustrated embodiment, the commerce server 212 can include a product database 214, a location database 216, and a consumer movement database 218. The commerce server 212 can also include a processing device 220 configured to include a correlation module 222, a selection module 224, and a transmission module 226.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 214 can include memory containing the identities of a plurality of products. The plurality of products can be the products offered for sale in a retail store associated with the commerce server 212. The retail store can be a physical retail store, an online retail store, or a combination including a physical retail store and an online retail store. A first plurality of products can be offered for sale in a physical retail store. A second plurality of products can be offered for sale through an online store associated with the physical store. At least some of the products can be part of the first plurality and the second plurality and thus offered for sale both online and in the physical store.

The product database 214 can contain an entry for each product and the entries can include data associating the product with one or more product categories. The entries in the product database 214 can also contain product specifications for each product. The specifications of a product can include the manufacturer of the product. The specifications of a product can also include physical dimensions, nutritional attributes, and/or materials used to make the product. The specifications of a product can also include the identity of the author and subject matter for a book, the performing artist and music category for a music product, as well as the actors and plot of a movie. The entries in the product database 214 can also include consumer reviews of the products. Relationships between products can also be contained in the product database 214. For example, the data stored in the product database 214 for a video game console can include references to video games that can be played on the video game console, controllers that can be used to play games on the video game console, and other accessories, such as skins that can be adhered to the video game console.

The product database 214 can also include promotions associated with one or more of the plurality of products. A product promotion can be a coupon, notification of a sale, or any other information that would tend to induce a consumer to purchase the product. The product promotions can be defined by video data, audio data, and/or text data. The data in the product database 214 can be organized based on one or more tables that may utilize one or more algorithms and/or indexes.

A system according to some embodiments of the present disclosure can be practiced such that a manufacturer of one of the products offered for sale, at a physical retail store or online, can be permitted to revise the data associated with product in the product database 214. As used herein, a “manufacturer” can be an entity making a product sold in the retail store and/or selling a product to a retail store for subsequent sale within the retail store (physical or online retail store). The manufacturer may desire to supplement the data in the product database 214 in order to more closely associate the product with one or more particular physical locations in the location database 216. The manufacturer may recognize that its product should be associated with certain locations and therefore be promoted to consumers visiting those locations. For example, the manufacturer of a sports beverage may desire to have its product correlated to a consumer's visit to sports stadium. The manufacturer can be charged for such database changes.

The location database 216 can include memory containing physical locations and data associated with the physical locations. For each location, the location database 216 can include the identity of the physical location, a physical address, GPS coordinates, a category of the physical location, an attraction available at the physical location, and a schedule of events occurring at the physical location. The location database 216 can be integral with the commerce server 212 or remote from the commerce server 212. The locations that are contained in the location database 216 can be organized based on one or more tables that may utilize one or more algorithms and/or indexes.

Systems according to some embodiments of the present disclosure can utilize a third-party database for location data. Alternatively, systems according to some embodiments of the present disclosure can incorporate or self-contain a location database 216. Alternatively, systems according to some embodiments of the present disclosure can practice a hybrid location database in which some data associated with physical locations is retrieved from a third-party database and other data is contained in an incorporated database. For example, in some embodiments of the present disclosure, the physical location, address and identity of a particular location can be retrieved from a third-party database while meta-data associated with the particular location can be stored in and retrieved from a self-contained database. The meta-data associated with the particular location would be portion of the location database maintained by the operator of an embodiment of the present disclosure.

A system according to an embodiment of the present disclosure can be practiced such that an owner of a particular physical location can be permitted to revise the data associated with the location in the location database 216, at least the portion of the location database maintained by the retailer. The location owner may desire to supplement the data in the location database 216 in order to more closely associate the location with one or more products in the product database 214. For example, the location owner may recognize that its location should be associated with certain products and therefore these products should be promoted to consumers visiting those locations. The location owner can be charged for such database changes.

The consumer movement database 218 can include memory containing entries for consumers. Each entry can include the particular physical locations that the consumer has visited. The consumer movement database 218 can also include data indicating the number of visits to each particular physical location, the number of visits to a category of physical locations, and the time spent at each location. The data contained in the consumer movement database 218 can be organized based on one or more tables that may utilize one or more algorithms and/or indexes.

The processing device 218 can communicate with the databases 214, 216, 218 and receive one or more signals from the mobile electronic computing device 14. The processing device 218 can include computer readable memory storing computer readable instructions and one or more processors executing the computer readable instructions.

The correlation module 222 can be operable to receive a series of position signals from the mobile electronic computing device 14 possessed by a consumer. The position signals can be continuously received from the commerce server 212. Alternatively, the position signals can be received from the mobile electronic computing device 14 possessed by the consumer at predetermined time intervals. The correlation module 222 can assess the location database 216 and identify particular physical locations in response to the data contained in the position signals. The correlation module 222 can also assess the consumer movement database 218 and store the identified physical locations in an entry associated with the particular consumer.

The correlation module 222 can also be operable to correlate each of the one or more particular physical locations received in the position signals with one or products contained in the product database 214. The correlation module 222 can correlate a specific product to a particular physical location based on identical terms found in the entry for the product in the product database 214 and in the entry for the location in the location database 216. The correlation can also be made based on analogous, synonymous or complementary terms found in the entries for the product and the location. The correlation module 222 can also correlate a specific product to a particular physical location based on data already stored in the consumer movement database 218, such as data indicating several previous visits to a particular physical location by the consumer.

A system according to an embodiment of the present disclosure can correlate a first particular physical location and a first product in response to a nature of the first particular physical location. For example, if the consumer visits a gym or park, the correlation module 222 can access the product database 214 and retrieve one or more products in a product category defined as “exercise” or “leisure.” The nature of gym or park can be exercise and leisure. The data stored in the location database 216 for each location can include a designation of a location category. “Exercise” and/or “leisure” can be location categories. The data stored in the product database 214 for each product can include a designation of a product category. “Exercise” and/or “leisure” can be product categories. The correlation module 222 can recognize that the visited, particular location is defined in part by its nature as being a place of exercise or leisure. The correlation module 222 can access the product database 214 and retrieve one or more products in the same product category or in a product category analogous or complementary to exercise or leisure. In another example, if the consumer regularly attends school, the correlation module 222 can access the product database 214 and retrieve one or more products in a product category defined as “office supplies” or “school supplies.”

A system according to an embodiment of the present disclosure can also correlate a first particular physical location and a first product in response to an attraction available at the first particular physical location. For example, if the consumer visits a Chinese restaurant, the correlation module 222 can access the product database 214 and retrieve one or more products in a product category defined as “food” and/or a subcategory “food/ethnic/Chinese.” The attraction available at a Chinese restaurant is Chinese food. The data stored in the location database 216 for each location can include a designation of an attraction category. “Food” can be a location category and “food/ethnic/Chinese” can be a location subcategory. The data stored in the product database 214 for each product can include a designation of a product category and subcategories. “Food” can be a product category and “food/ethnic/Chinese” can be a product subcategory. The correlation module 222 can recognize that the visited, particular location is defined in part by the attraction available at the particular location as being a place to obtain food and, more particularly, a place to obtain Chinese food. The correlation module 222 can access the product database 214 and retrieve one or more products in the same product category or in a product category analogous or complementary to food or more specifically Chinese food.

A system according to an embodiment of the present disclosure can also correlate a first particular physical location and a first product in response to an identity of the first particular physical location. For example, several national restaurant chains now offer pre-packaged products in the frozen food sections of retail stores. If the consumer visits such a restaurant, the correlation module 222 can access the product database 214 and retrieve one or more products sharing the identity of the national restaurant chain. Also, data in the product database 214 can identify the manufacturer of each product and, if the consumer visits such a restaurant, the correlation module 222 can access the product database 214 and retrieve one or more products manufactured by the national restaurant chain. The correlation module 222 can thus access the product database 214 and retrieve one or more products in response to an identity of the first particular physical location.

A system according to an embodiment of the present disclosure can also determine a positive correlation between a first particular physical location and a first product in response to data in the consumer movement database 218. A determination of a positive correlation can prompt the selection module 224 to select a product promotion for the first product for transmission to the consumer. For example, a consumer may visit a venue for a sporting event several times. The location database 216 may include data indicating that a particular sports team was playing at the venue during each visit by the consumer. The consumer's visits to the venue can be stored in the consumer movement database 218 as well as the attraction at the venue (the sports team) during each visit.

The data stored in the product database 214 for each product can include a designation of a product category and subcategories. “Apparel” can be a product category and “apparel/sports/team” can be a product subcategory. The correlation module 222 can recognize that the several visits by the consumer to the venue correspond to an interest in the team by the consumer. The correlation module 222 can access the product database 214 and retrieve one or more products in the same product subcategory as “apparel/sports/team.” The selection module can select promotions for these products and direct the transmission module to direct the promotions to the consumer. Thus, the data in the consumer movement database 218 was applied to determine a positive correlation; a product corresponding to the location was promoted.

A system according to an embodiment of the present disclosure can also determine a negative correlation between a first particular physical location and a first product in response to data in the consumer movement database 218. A determination of a negative correlation can either cause the correlation module to refrain from making a correlation or prompt the selection module 224 to reject a product promotion for the first product for transmission to the consumer. For example, a consumer may frequent restaurants. The consumer's visits to the restaurants can be stored in the consumer movement database 218. The frequency of eating out can be recognized by the correlation module 222 as an indication that the consumer is not interested, generally, in purchasing groceries. Therefore, the correlation module 222 can forego establishing a correlation between this consumer's movements and the product category “food.” The selection module 224 will therefore not select a promotion for products within the category of “food” since the correlation module 222 has not identified a correlation.

In some embodiments, the correlation module 222 can be configured to draw correlations and the selection module 224 can be configured to establish a negative correlation. In other words, in some embodiments, the selection module 224 can refrain from selecting promotions on groceries based on data in the consumer movement database 218 that the consumer eats out frequently. Thus, the data in the consumer movement database 218 can be applied by the selection module 224 or the correlation module 222 to determine a negative correlation.

A system according to an embodiment of the present disclosure can also correlate a first particular physical location and a first product in response to a nature of the first particular physical location and the specifications of the first product. For example, if the consumer regularly visits a gym or park, the commerce server 212 can access the product database 214 and retrieve one or more products having a specification including a term such as “healthy,” “organic,” or “low-fat.” The nature of gym or park can be exercise. The data stored in the location database 216 for each location can include a designation of a location category. “Exercise” can be a location category. The data stored in the product database 214 for each product can include specifications for a product. “Healthy” and/or “low-fat” can be terms contained in the product specifications. These terms can also define product categories or may not be applied to define the product category. The correlation module 222 can recognize terms defining the nature of location as being synonymous and/or analogous to terms in the specification of a product. The correlation module 222 can access the product database 214 and retrieve one or more products described by terms in a specification that are synonymous and/or analogous to terms describing a location in the location database 216. The terms relied upon for correlation by the correlation module 222 need not be in the same general field of data. For example, the terms relied upon for correlation may not be in the “nature of location” and “nature of product” categories.

A system according to an embodiment of the present disclosure can also correlate a first particular physical location and a first product in response to a schedule of events occurring at the first particular physical location and the specifications of the first product. For example, if the consumer attends a concert at a theater, performed by a particular entertainer, the commerce server 212 can access the product database 214 and retrieve one or more products having a specification including the name of the particular entertainer. The data stored in the location database 216 for locations/venues such as theaters, concert halls, and stadiums can include schedule of events for the venue. The names of entertainers or sports teams can be data contained in such a schedule of events. The data stored in the product database 214 for each product can include specifications for a product. The specifications can include the author of a book, the performer on a CD, or an actor appearing on DVD. The correlation module 222 can thus access the product database 214 and retrieve one or more products described by terms in a specification that are also found in a schedule of events associated with a location in the location database 216.

The correlation module 222 can communicate the identities of the products that have been correlated to the consumer (in response to the physical locations visited by the consumer) to the selection module 224. The selection module 224 can select one or more promotions from the product database 214 and direct the transmission module 226 to transmit all or some of the promotions gathered to the mobile electronic computing device 14 for display to the consumer.

A system according to an embodiment of the present disclosure can store in the consumer movement database 218 the number of times that a consumer visits each particular physical location. A system according to an embodiment of the present disclosure can be configured to select promotions in response to some predetermined number of visits. For example, the selection module 224 in some embodiments of the present disclosure may not be configured to select a promotion for Mexican food products in response to a single visit by a consumer to a Mexican restaurant. However, in some embodiments of the present disclosure, the selection module 224 in some embodiments of the present disclosure may be configured to select promotions Mexican food and cook books for Mexican food in response to five visits to the Mexican restaurant. The selection module 214 can also be configured to recognize patterns more general than the number of visits to a particular restaurant.

The transmission module 226 can transmit the product promotion to the mobile electronic computing device 14 in a promotion signal. The promotion signal that is transmitted to the mobile electronic computing device 14 can be a form of electronic file that includes video, audio, graphic, and/or text data. The processor 40 can receive the signal from the transmission module 48 and display the product promotions through the display 20 and/or through a speaker 52.

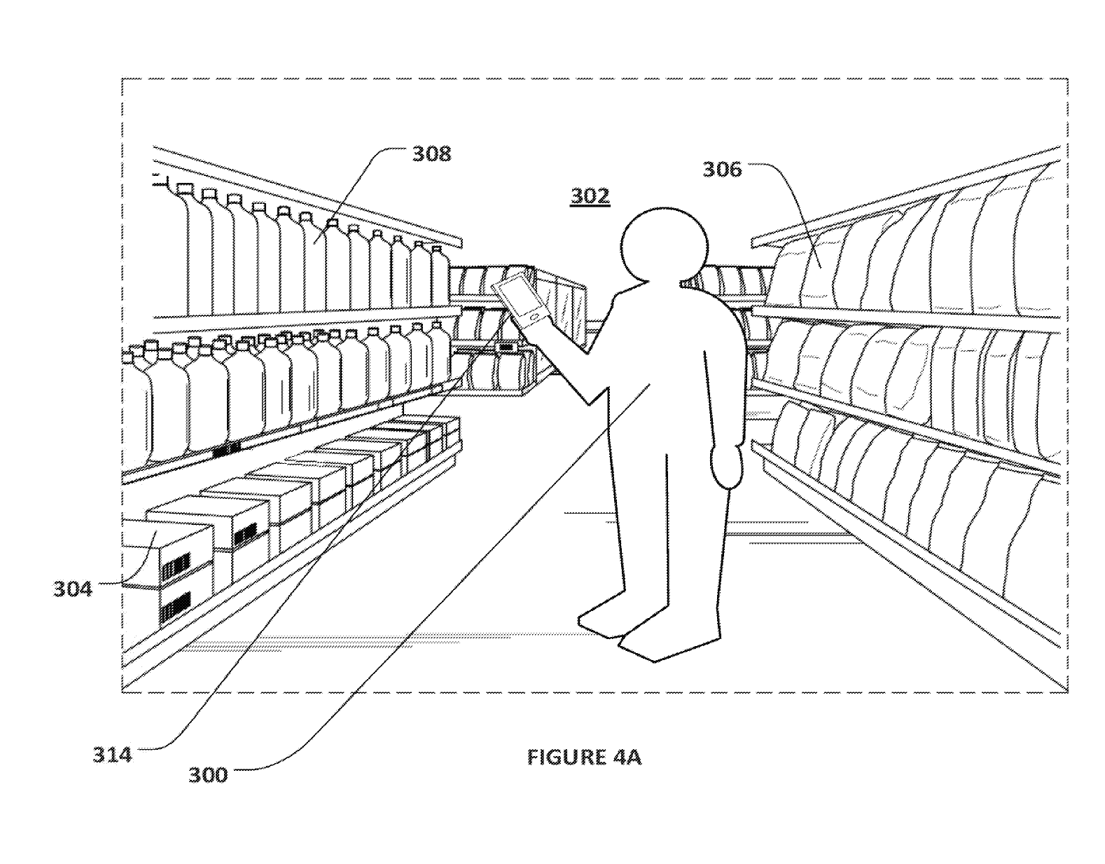

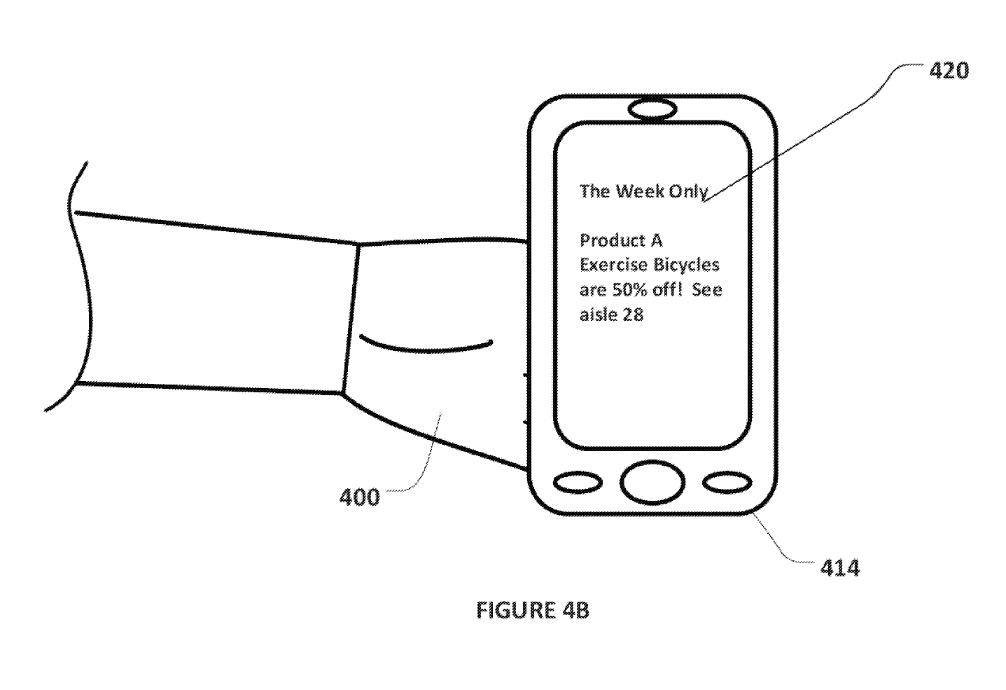

FIG. 4A is a perspective view of an operating environment of an exemplary embodiment of the present disclosure. FIG. 4A is a perspective view of a consumer 300 while shopping in some embodiments of the present disclosure. The consumer 300 can be within a retail store 302, amid shelving supporting various products 304, 306, 308 offered for sale in the retail store 302. The consumer can be operating a mobile electronic computing device 314, such as a smart phone. The commerce server 212 can receive a position signal indicating that the consumer 300 is within the physical store shopping. The selection module 224 can be prompted to now deliver product promotions selected in response to the consumer's movements outside the retail store.

In some embodiments, the consumer 300 can direct the transmission of position signals through an app on the electronic computing device 314. An app can be software used on a smart phone or another mobile device. An app can also be software that is accessed and used while online, with a browser, instead of software residing on the electronic computing device. An app can be a software program or a set of programs created to significantly improve existing functions of a device or to provide a device with new function. The commerce server 212 can transmit the app to the electronic computing device 314 in some embodiments of the present disclosure. The use of an app by the consumer can simplify the processing of the signals for the commerce server 212.

FIG. 4B is an illustration from a consumer's point of view showing an example display 420 visible with a mobile electronic computing device 414 after receipt of a product promotion. The consumer's hand 400 is visible holding the mobile electronic computing device 414, such as a smart phone. FIG. 4B. illustrates that the commerce server 212 has correlated a consumer's previous visits to a gym with an exercise bicycle. The commerce server 212 has selected and transmitted a product promotion in the form of a notice of a sale on the exercise bicycle. This information is shown on the display 420.

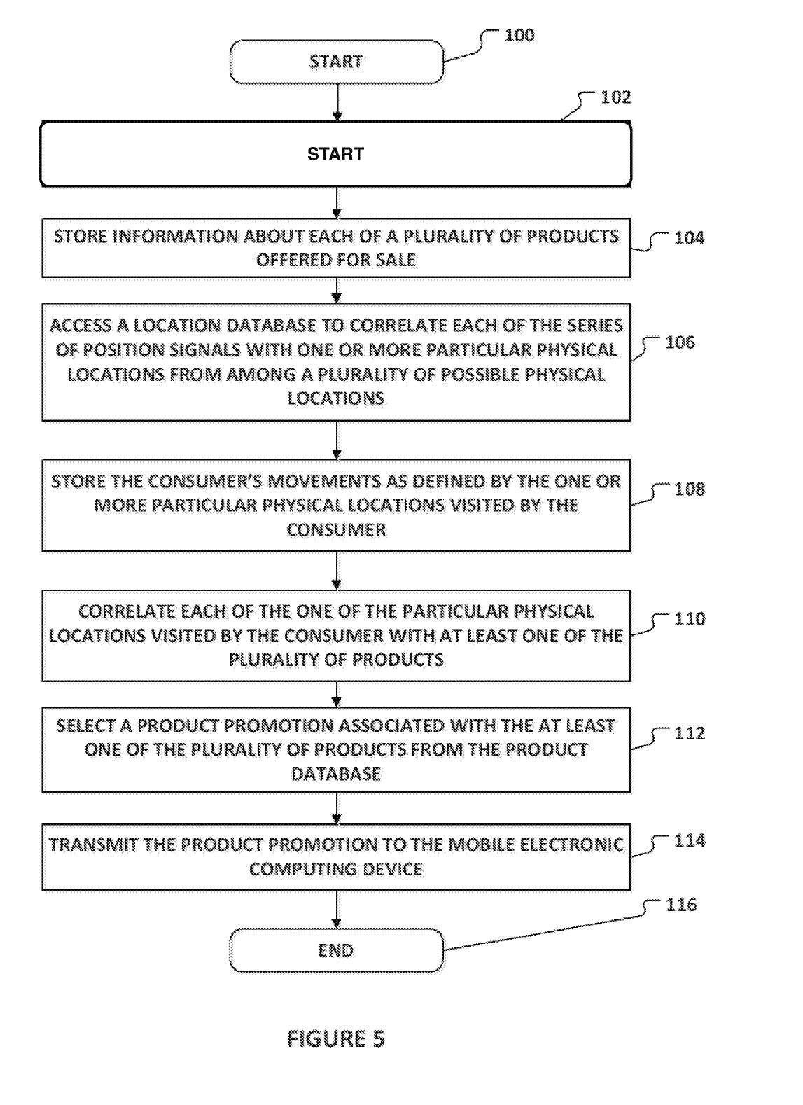

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The exemplary method shown in FIG. 5 can be executed by a processor of a commerce server. The method starts at step 100. At step 102, the commerce server can receive a series of position signals from a mobile electronic computing device possessed by a consumer. At step 104, the commerce server can store information about each of a plurality of products offered for sale. At step 106, the commerce server can access a location database to correlate each of the series of position signals with one or more particular physical locations from among a plurality of possible physical locations. At step 108, the commerce server can store the consumer's movements as defined by the one or more particular physical locations visited by the consumer. At step 110, the commerce server can correlate each of the one of the particular physical locations visited by the consumer with at least one of the plurality of products. At step 112, the commerce server can select a product promotion associated with the at least one of the plurality of products from the product database. At step 114, the commerce server can transmit the product promotion to the mobile electronic computing device. The exemplary method ends at step 116.

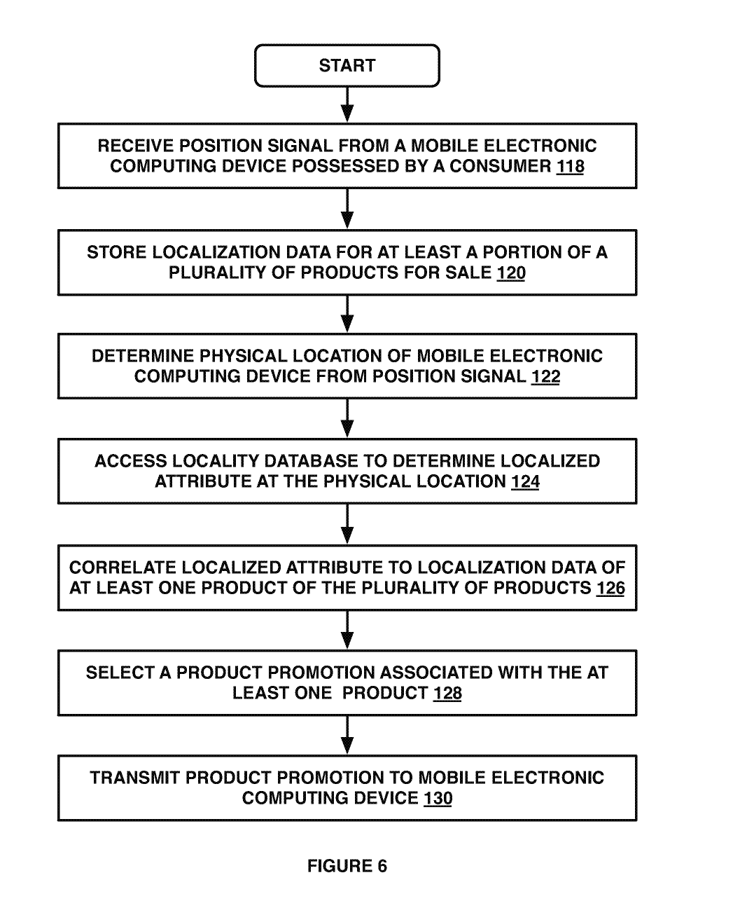

FIG. 6 is a flow chart illustrating an other method that can be carried out in some embodiments of the present disclosure in addition to, or as an alternative to the method of FIG. 5. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The method of FIG. 6 may include receiving 118 one or more position signals from the mobile electronic computing device 14 as for other embodiments disclosed herein. In the method of FIG. 6 a single position signal or multiple position signals may be received. For example, position signals over a certain amount of time may be received 118 and processed according of the method or a single position signal may be received 118.

Localization data for one or more products offered for sale may be stored 120. Localization data may be stored for some products in a product database of a merchant or other entity or for only a portion of products in a product database of a merchant or other entity. Localization data for a product may be data indicating suitability or availability of a product for a specific geographic region or class or category of geographic regions. For example, a product may have local cultural appeal such as foods, decorations, clothing, or other products that are part of a traditional culture for a region of a country or a country. Accordingly, localization data for such a product will indicate the region, country, or other political or geographical description of where the product is popular or known. Localization data may account for different types of weather. For example, a product may be classified as a temperate product (e.g. shorts, lightweight shirts and pants, etc.), hot weather product (e.g. sandals, tank top, etc.), winter product (winter boots, coats, snow pants, etc.), a wet weather product (galoshes, umbrellas, waterproof jackets and pants, etc.). A weather type may be defined as a temperature range, precipitation type (rain, snow), precipitation intensity (e.g. inches/hour), a metric of sun intensity, or some other characterization of weather conditions. An indication or suitability of a product for a particular weather type may be stored as localization data for that product. Some products (e.g. food) aren't related to a particular weather type and no indication of weather suitability may be stored with such products. In some embodiments, products suitable for a certain weather type may be unsuitable for another weather type. Accordingly, localization data may indicate one or more weather types for which a product is suitable and one or more weather types for which the product is not suitable. Localization data may be stored in a single database or distributed among a plurality databases. For example, a local database associated with a particular geographic region may store localization data for products that are affiliated of locally popular to that region.

The method of FIG. 6 may include determining 122 a physical location of the mobile electronic computing device 14 from which the position signal was received 118. Determining 122 the physical location may be according to any of the approaches described herein. In some embodiments, determining 122 the physical location may include estimating a residence of the user associated with the mobile electronic computing device 14. For example, position signals over a time period of a number of days, e.g. one or two weeks or one or two days, may be analyzed to determine a centroid or average position indicated by the position signals. This average position may then be determined 122 to be the physical location. In some embodiments, a single position signal, such as the most recent position signal at the time of execution of the method of FIG. 6 is performed, may be used.

A locality database may be accessed 124 to determine one or more localized attributes at the physical location. Locality database may store weather data for various geographic regions or points. Locality database may also identify cultural characteristics of a particular geographic region.

The one or more localized attributes determined at step 124 may be correlated 128 to location data of one or more products of a plurality of products to identify one or more products having localization data, such as described with respect to step 120, that indicates a relationship with the determined 122 physical location. For example, if a product is identified as used in creole cooking and the physical location is in or around New Orleans, the product may be identified at step 124 as relating to the physical location. In another example, if a product is identified as being suitable for winter weather (e.g. snow/cold), and the locality database indicates that the physical location is currently experiencing winter conditions based on current meteorological conditions or typical seasonal weather patterns (e.g. seasonal variations in temperature and precipitation), the product may be identified as related to the physical location. Similarly, products having localization data indicating suitability for summer may be identified at step 124 as being relate to a physical location having locality data indicating that it is currently experiencing warm and/or dry conditions or is in a warm and/or dry season based on typical seasonal weather patterns.

Step 124 may include eliminating from consideration products that have a negative relationship to the physical location. For example, if the locality data indicates that the physical location indicates winter weather, products having localization data indicating unsuitability for winter weather may be eliminated from consideration.

For one or more of the products identified at step 126 as being related to the physical location, a promotion may be selected 128. A promotion maybe selected 128 according to any of the methods for selecting a promotion as described herein. A promotion may be selected from a number of promotions associated with the one or more products independent of execution of the method of FIG. 6. A promotion may also be automatically defined for the product based on a promotion generating rules. For example, a promotion may simply be generated that defines a percentage discount (e.g. 10 percent, 20 percent, or the like), a buy-one-get-one-free (BOGO) deal, or some other promotion or advertisement.

The product promotion selected at step 128 may then be transmitted 130 to the mobile electronic computing device. The promotion may describe the promotion as described above and may further identify the product or class of products for which the promotion applies. Transmitting 130 the promotion may be performed according to any of the methods described herein.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
receiving, at a processing device of a commerce server, at least one position signal at at least one time from a mobile electronic computing device possessed by a consumer;
determining, with the processing device, from the at least one position signal at least one physical location of the mobile electronic computing device;
accessing, with the processing device, a locality database to determine at least one localized attribute for the at least one physical location;
correlating, with the processing device, the at least one localized attribute with at least one product of the plurality of products according to correspondence of the localized attribute and localization data associated with the at least one product of the plurality of products;
selecting, with the processing device, a product promotion associated with the at least one of the plurality of products from the product database; and
transmitting, with the processing device, the product promotion to the mobile electronic computing device.

2. The computer-implemented method of claim 1, wherein accessing the locality database to determine at least one localized attribute for the at least one physical location comprises obtaining current weather conditions for the at least one physical location at the at least one time.

3. The computer-implemented method of claim 3, wherein the at least one of the plurality of products are associated with the typical weather conditions for the season including the at least one time at the at least one physical location.

4. The computer-implemented method of claim 1, wherein said receiving step further comprises:
continuously receiving, with the processing device, the position signal from the mobile electronic computing device.

5. The computer-implemented method of claim 1, wherein said receiving step further comprises:
receiving, with the processing device, the series of position signals from the mobile electronic computing device possessed by the consumer for tracking the consumer's movements, wherein position signals are received at predetermined time intervals.

6. The computer-implemented method of claim 1, wherein said accessing step further comprises:
maintaining at least a portion of the locality database.

7. The computer-implemented method of claim 1 wherein said locality database includes at least one of seasonal temperature variations and seasonal precipitation variations for each of a plurality of possible physical locations including the at least one physical location.

8. The computer-implemented method of claim 7, wherein said correlating step further comprises:
determining, with the processing device, a positive correlation between the at least one physical location and a first product in response to a suitability of the first product to current weather conditions based on the at least one physical location at the at least one time based on the at least one of seasonal temperature variations and seasonal precipitation.

9. The computer-implemented method of claim 8, wherein said correlating step further comprises:
determining, with the processing device, a negative correlation between the at least one physical location and a second product in response to an unsuitability of a second product to current weather conditions based on the at least one physical location at the at least one time based on the at least one of seasonal temperature variations and seasonal precipitation.

10. The computer-implemented method of claim 1, wherein said transmitting step further comprises:
transmitting, with the processing device, the product promotion to the mobile electronic computing device in a promotion signal containing at least one of video data and audio data.

11. The computer-implemented method of claim 1, wherein said storing step further comprises:
storing, in a product database, information about each of a plurality of products offered for sale including identities of the plurality of products, a product category of each of the plurality of products, specifications of at least some of the plurality of products, a manufacturer of at least some of the plurality of products, suitability of each of the plurality of products for types of weather, and at least one promotion for at least one of the plurality of products.

12. A method of selling products comprising:
providing a first plurality of products for sale in a physical retail store;
offering a second plurality of products for sale through an online store, wherein at least some of the products are part of the first plurality and the second plurality;
receiving, at a processing device of a commerce server, at least one position signal from a mobile electronic computing device possessed by a consumer, wherein the at least one physical location signal originates from outside of the physical retail store and is received at at least one time;
storing, in a product database, information about each of the first and second pluralities of products offered for sale, the information including a suitability of each product of the plurality of products for one or more weather types;
accessing, with the processing device, a location database to correlate the at least one position signal with at least one physical location from among a plurality of possible physical locations;
accessing, with the processing device, a weather database to obtain current weather conditions for the at least one physical location at the at least one time;
correlating, with the processing device, the at least one physical location with at least one product of the first and second pluralities of products based on correspondence between the suitability of the at least one product of the first and second pluralities of products for one or more weather types and the current weather conditions for the least one physical location;
selecting, with the processing device, a product promotion associated with the at least one of the first and second pluralities of products from the product database; and
transmitting, with the processing device, the product promotion to the mobile electronic computing device.

13. The method of claim 12, wherein the current weather conditions includes typical weather conditions at the at least one physical location for a season including the at least one time.

14. The method of claim 13, wherein the at least one of the plurality of products are associated with the typical weather conditions for the season.

15. The method of claim 12, wherein said receiving step further comprises:
receiving, with the processing device, the series of position signals from the mobile electronic computing device possessed by the consumer for tracking the consumer's movements, wherein position signals are received at predetermined time intervals.

16. The computer-implemented method of claim 12, wherein said the weather database includes at least one of seasonal temperature variations and seasonal precipitation variations for each of the plurality of possible physical locations.

17. The method of claim 12, wherein said correlating step further comprises:
determining, with the processing device, a positive correlation between the at least one physical location and a first product in response to a suitability of the first product to the current weather conditions at the at least one physical location at the at least one time.

18. The computer-implemented method of claim 17, wherein said correlating step further comprises:
determining, with the processing device, a negative correlation between the at least one physical location and a second product in response to an insuitability of the first product to the current weather conditions at the at least one physical location at the at least one time.

19. The method of claim 12, wherein said transmitting step further comprises:
transmitting, with the processing device, the product promotion to the mobile electronic computing device in a promotion signal containing at least one of video data and audio data.

20. The computer-implemented method of claim 12, wherein said storing step further comprises:
storing, in a product database, information about each of a plurality of products offered for sale including identities of the plurality of products, a product category of each of the plurality of products, specifications of at least some of the plurality of products, a manufacturer of at least some of the plurality of products, suitability of each of the plurality of products for types of weather, and at least one promotion for at least one of the plurality of products.
